(19) United States
(12) Patent Application Publication
(10) Pub. No.: US 2012/0176447 A1
(43) Pub. Date: Jul. 12, 2012

(54) LIQUID EJECTING HEAD AND LIQUID EJECTING APPARATUS

(75) Inventor: Kenji OTOKITA, Higashichikuma (JP)

(73) Assignee: SEIKO EPSON CORPORATION, Shinjuku-ku (JP)

(21) Appl. No.: 13/347,588

(22) Filed: Jan. 10, 2012

(30) Foreign Application Priority Data
Jan. 11, 2011 (JP) 2011-002756

(51) Int. Cl. B41J 2/145

(52) U.S. Cl. 347/40

(57) ABSTRACT

A liquid ejecting head, in which a plurality of pressure chambers that communicate with corresponding nozzles are formed by partitions, that ejects a liquid through the nozzles that communicate with the pressure chambers by causing an active surface (an elastic membrane) that seals an opening surface of the pressure chambers to deform using a piezoelectric element and thus causing the pressure of the liquid within the pressure chambers to fluctuate. The partitions that separate adjacent pressure chambers from each other are formed having a plurality of levels, the plurality being three or more, so that the partitions become thicker from the side on which the active surface is present toward the side on which the nozzles are present.

### BACKGROUND

1. Technical Field

The present invention relates to liquid ejecting heads mounted in liquid ejecting apparatuses such as ink jet recording apparatuses and to liquid ejecting apparatuses in which such liquid ejecting heads are mounted, and particularly relates to liquid ejecting heads and liquid ejecting apparatuses that eject a liquid through a nozzle by causing an active surface that configures part of a pressure chamber communicating with the nozzle to displace and causing a fluctuation in the pressure of a liquid within the pressure chamber.

2. Related Art

A liquid ejecting apparatus is an apparatus that includes a liquid ejecting head capable of ejecting a liquid as droplets through a nozzle, and that ejects various types of liquid from this liquid ejecting head. An image recording apparatus such as an ink jet recording apparatus (a printer) that includes an ink jet recording head (called simply a “recording head” hereinafter) and carries out recording by ejecting ink in liquid form through nozzles in the recording head as ink droplets can be given as an example of such a liquid ejecting apparatus. In addition, liquid ejecting apparatuses are also used to eject other various types of liquids; for example, coloring materials used in the color filters of liquid-crystal displays and so on, organic materials used in organic EL (electroluminescence) displays, electrode materials used in the formation of electrodes, and so on. While a recording head in an image recording apparatus ejects ink in liquid form, a coloring material ejecting head in a display manufacturing apparatus ejects R (red), G (green), and B (blue) coloring material solutions. Likewise, an electrode material ejecting head in an electrode formation apparatus ejects an electrode material in liquid form, and a bioorganic matter ejecting head in a chip manufacturing apparatus ejects a bioorganic matter solution.

A recording head mounted in a printer as described above is configured so as to introduce ink from an ink supply source such as an ink cartridge into the pressure chamber, cause a fluctuation in the pressure of the ink within the pressure chamber by causing an active surface that seals an opening of the pressure chamber to displace as a result of causing a piezoelectric element to operate, and ultimately eject the ink within the pressure chamber as ink droplets through the nozzle by using the fluctuation in the pressure. With such a recording head, a plurality of nozzles are disposed at a high density in order to improve the image quality of the recorded image. Accordingly, pressure chambers that communicate with the respective nozzles are also formed at a high density, and thus there is a tendency for the partitions that separate adjacent pressure chambers and other flow channels from each other to be extremely thin. Accordingly, what is known as “adjacent crosstalk,” which occurs between adjacent nozzles, is a problem.

With respect to this problem, there has been proposed a configuration that increases the rigidity of the partitions by employing a dual-level structure for the pressure chambers (pressure generation chambers), widening the pressure chambers that are closer to the piezoelectric elements (called the “first level” hereinafter) and narrowing the pressure chambers that are further from the piezoelectric elements (called the “second level” hereinafter) (for example, see JP-A-2001-287360).

However, with the stated configuration, there is a large difference between the thickness of the partitions of the first-level pressure chambers and the thickness of the partitions of the second-level pressure chambers (that is, a large level difference), and thus there is a risk that the partitions of the second-level pressure chambers will interfere when the piezoelectric element and the active surface (that is, a vibrating plate) displace. On the other hand, in the case where the height of the first-level pressure chamber partitions is increased in order to prevent interference between the piezoelectric elements and active surface and the partitions, there is a problem in that the durability of the first-level partitions drops by that amount, making the first-level partitions more likely to fail.

It should be noted that this problem is not limited only to ink jet recording apparatuses provided with recording heads that eject ink; the problem also exists in other liquid ejecting heads and liquid ejecting apparatuses that have a plurality of pressure chambers with partitions therebetween and eject a liquid through a nozzle by using piezoelectric elements to cause an active surface that seals an open surface of the pressure chambers to deform and cause a fluctuation in the pressure of the liquid within the pressure chambers as a result.

### SUMMARY

It is an advantage of some aspects of the invention to provide a liquid ejecting head and a liquid ejecting apparatus capable of preventing crosstalk from occurring when ejecting a liquid.

A liquid ejecting head according to an aspect of the invention is a liquid ejecting head, in which a plurality of pressure chambers that communicate with corresponding nozzles are formed by partitions, that ejects a liquid through the nozzles that communicate with the pressure chambers by causing an active surface that seals an opening surface of the pressure chambers to deform using a pressure generation unit and thus causing the pressure of the liquid within the pressure chambers to fluctuate; the partitions that separate adjacent pressure chambers from each other are formed having a plurality of levels, the plurality being three or more, so that the partitions become thicker from the side on which the active surface is present toward the side on which the nozzles are present.

According to this aspect of the invention, the partitions that separate the pressure chambers from each other are formed having a plurality of levels, the plurality being three or more, and the partitions become thicker from the side on which the active surface is present toward the side on which the nozzles are present; accordingly, it is possible to increase the rigidity of the partitions as a whole without interfering with the displacement of the pressure generation unit and the active surface. For this reason, the partitions are suppressed from deforming toward their adjacent pressure chambers when the pressure within the pressure chambers rises due to the pressure generation unit operating in order to eject the liquid through the nozzles. Through this, pressure loss is reduced, and crosstalk between adjacent nozzles is prevented. As a result, it is possible to suppress fluctuations in the liquid ejection properties caused by crosstalk (that is, fluctuations in the amount, flight speed, and so on of the liquid ejected through the nozzles). In addition, because the durability of the partitions is increased, the reliability of the liquid ejecting head can be improved. Furthermore, setting the partitions to have three or more levels reduces the level differences between partitions, which makes it possible to prevent bubbles from accumulating in order to ensure that the liquid within the pressure chambers flows smoothly.

In the aforementioned configuration, it is desirable to employ a configuration in which, of the plurality of partitions, the thickness and height of the partition located closest to the active surface are set so that a maximum displacement amount necessary for the active surface when ejecting the liquid through the nozzles is obtained, and of the plurality of partitions, the thickness and height of the partition located closest to the nozzle are set to be thick within a range in which the flow channel from the pressure chamber to the nozzle is not narrowed.

According to this configuration, the thickness and height of the partition located closest to the active surface are set so that a maximum displacement amount necessary for the active surface when ejecting the liquid through the nozzles is obtained, and the thickness and height of the partition located closest to the nozzle are set to be thick within a range in which the flow channel from the pressure chamber to the nozzle is not narrowed; accordingly, it is possible to increase the rigidity of the partitions as a whole without interfering with the displacement of the pressure generation unit and the active surface. For this reason, the partitions are suppressed from deforming toward their adjacent pressure chambers when the pressure within the pressure chambers rises due to the pressure generation unit operating in order to eject the liquid through the nozzles. Through this, pressure loss is reduced, and crosstalk between adjacent nozzles is prevented with more certainty.

A liquid ejecting apparatus according to another aspect of the invention is a liquid ejecting apparatus including a liquid ejecting head, in which a plurality of pressure chambers that communicate with corresponding nozzles are formed by partitions, that ejects a liquid through the nozzles that communicate with the pressure chambers by causing an active surface that seals an opening surface of the pressure chambers to deform using a pressure generation unit and thus causing the pressure of the liquid within the pressure chambers to fluctuate; in the liquid ejecting head, the partitions that separate adjacent pressure chambers from each other are formed having a plurality of levels, the plurality being three or more, so that the partitions become thicker from the side on which the active surface is present toward the side on which the nozzles are present.

### BRIEF DESCRIPTION OF THE DRAWINGS

The invention will be described with reference to the accompanying drawings, wherein like numbers reference like elements.

FIG. 1 is a perspective view illustrating the configuration of a printer.

FIGS. 2A, 2B, and 2C are front views illustrating the configuration of a recording head.

FIG. 3 is an enlarged cross-sectional view illustrating the principal constituent elements of a recording head.

### DESCRIPTION OF EXEMPLARY EMBODIMENTS

Hereinafter, an embodiment of the invention will be described with reference to the appended drawings. Although various limitations are made in the embodiment described hereinafter in order to illustrate a specific preferred example of the invention, it should be noted that the scope of the invention is not intended to be limited to this embodiment unless such limitations are explicitly mentioned hereinafter. An ink jet recording apparatus (referred to as a “printer 1”) provided with a recording head 2, which is a type of liquid ejecting head, will be described hereinafter as an example of a liquid ejecting apparatus according to the invention.

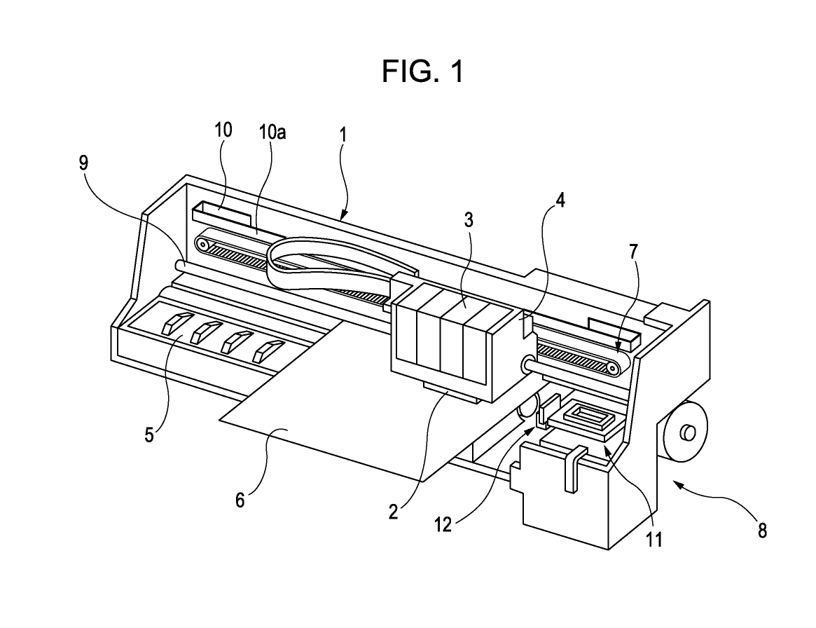

FIG. 1 is a perspective view illustrating the configuration of the printer 1. The printer 1 includes: a carriage 4, to which the recording head 2 is attached, and to and from which ink cartridges 3, which are a type of liquid supply source, can be attached and removed; a platen 5 that is disposed below the recording head 2 during recording operations; a carriage movement mechanism 7 that causes the carriage 4 to move back and forth in the paper width direction of recording paper 6 (a type of recording medium and a type of landing target), or in other words, to move back and forth in the main scanning direction; and a paper feed mechanism 8 that transports the recording paper 6 in the sub scanning direction, which is orthogonal to the main scanning direction.

The carriage 4 is attached in a state in which it is axially supported by a guide rod 9 that is provided along the main scanning direction, and the configuration is such that the carriage 4 moves in the main scanning direction along the guide rod 9 as a result of operations performed by the carriage movement mechanism 7. The position of the carriage 4 in the main scanning direction is detected by a linear encoder 10, and that detection signal, or in other words, an encoder pulse is sent to a printer controller (not shown). The linear encoder 10 is a type of position information output unit, and outputs an encoder pulse based on the scanning position of the recording head 2 as position information in the main scanning direction. Accordingly, the printer controller is capable of recognizing the scanning position of the recording head 2 mounted in the carriage 4 based on the received encoder pulse. In other words, the position of the carriage 4 can be recognized by, for example, counting the received encoder pulses. Through this, the printer controller can control the recording operations performed by the recording head 2 while recognizing the scanning position of the carriage 4 (the recording head 2) based on the encoder pulse from the linear encoder 10.

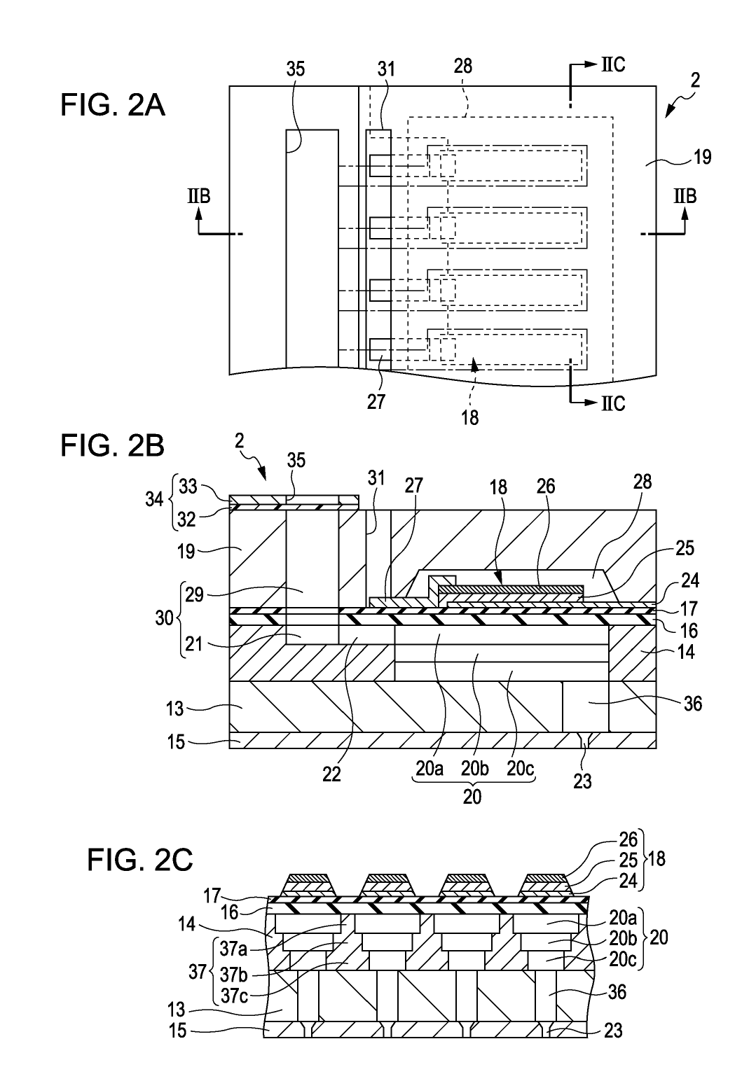

A home position, which serves as a base point for the scanning performed by the carriage, is set within the movement range of the carriage 4 in an end region that is outside of the recording region. A capping member 11 that seals a nozzle formation surface (a nozzle formation substrate 15; see FIGS. 2A to 2C) of the recording head 2 and a wiper member 12 for wiping the nozzle formation surface are provided at the home position in this embodiment. The printer 1 is configured so as to be capable of so-called bidirectional recording, in which text, images, or the like are recorded upon the recording paper 6 both when the carriage 4 is outbound, moving toward the end that is on the opposite side of the home position, and when the carriage 4 is inbound, returning toward the home position from the end that is on the opposite side of the home position.

FIGS. 2A through 2C are diagrams illustrating the configuration of the recording head 2 according to this embodiment; FIG. 2A is a plan view of the recording head 2, FIG. 2B is a cross-sectional view taken along the IIB-IIB line shown in FIG. 2A, and FIG. 2C is a cross-sectional view taken along the IIC-IIC line shown in FIG. 2A. Although FIGS. 2A through 2C show examples of a configuration in which there are four nozzles, the configurations corresponding to the remainder of the nozzles are the same. The recording head 2 according to this embodiment is configured having a communication opening substrate 13, a flow channel formation substrate 14, the nozzle formation substrate 15, an elastic membrane 16, an insulating membrane 17, piezoelectric elements 18, a protective substrate 19, and so on in a stacked state.

The flow channel formation substrate 14 is a plate-shaped member that is configured of, for example, a silicon single-crystal substrate. A plurality of pressure chambers 20 are arranged in parallel in the flow channel formation substrate 14 along the width direction (that is, the nozzle row direction) thereof, with partitions 37 provided therebetween. As will be described later, the partitions 37 that separate the pressure chambers from each other are configured of a plurality of levels (37a to 37c) having different thicknesses (this refers to the dimensions in the nozzle row direction). A communication portion 21 is formed in a region of the flow channel formation substrate 14 that is on the outside of the pressure chambers 20 in the lengthwise direction, and the communication portion 21 and the respective pressure chambers 20 communicate with each other via ink supply channels 22 that are provided for each of the pressure chambers 20. Note that the communication portion 21 communicates with a reservoir portion 29 in the protective substrate 19, which will be mentioned later, and thus configures part of a reservoir 30 that serves as a common ink chamber that is shared by the pressure chambers 20. The ink supply channels 22 are formed so as to be narrower than the pressure chambers 20, and thus impart a constant flow channel resistance on the ink that flows into the pressure chambers 20 from the communication portion 21. The flow channels in the flow channel formation substrate 14, which are configured of the pressure chambers 20, the ink supply channels 22, and so on, are formed through anisotropic etching.

The communication opening substrate 13, in which communication openings 36 are provided, is affixed, using an adhesive, a heat-welded film, or the like, to one surface (the bottom surface, in FIG. 2B) of the flow channel formation substrate 14. Meanwhile, the nozzle formation substrate 15, in which a plurality of nozzles 23 are provided in a row in correspondence with the respective pressure chambers 20, is affixed, using an adhesive or the like, to the surface opposite to the bonded surface between the flow channel formation substrate 14 and the communication opening substrate 13. A plurality of the communication openings 36 of the communication opening substrate 13 are formed in correspondence to the respective pressure chambers 20, and are formed so as to pass through the communication opening substrate 13 in the thickness direction thereof. One end (the top end in FIG. 2B) of each communication opening 36 communicates with its corresponding pressure chamber 20 on the end thereof that is on the opposite side as the corresponding ink supply channel 22, whereas the other end (the bottom end in FIG. 2B) of each communication opening 36 communicates with a corresponding nozzle 23 in the nozzle formation substrate 15. The width (that is, the dimension in the nozzle row direction) of each communication opening 36 according to this embodiment is slightly narrower than the minimum width of each pressure chamber 20 (the width of a third pressure chamber 20c, which will be described later).

The elastic membrane 16, which is configured of, for example, silicon dioxide (SiO₂), is formed on the other surface of the flow channel formation substrate 14. The portion of the elastic membrane 16 that seals the openings of the pressure chambers 20 corresponds to the “active surface” according to the invention. Meanwhile, the insulating membrane 17, configured of zirconium dioxide (ZrO₂), is formed upon the elastic membrane 16; furthermore, a lower electrode 24, piezoelectric materials 25, and upper electrodes 26 are formed upon the insulating membrane 17 in a stacked state, configuring the piezoelectric elements 18 (a type of pressure generation unit). Generally speaking, one of the electrodes in the piezoelectric elements 18 is used as a common electrode, whereas the other electrodes (positive-polarity or individual electrodes) and the piezoelectric materials 25 are configured for each of the pressure chambers 20 through patterning. Furthermore, here, the portion configured from one of the electrodes and the piezoelectric materials 25 obtained through patterning, and in which piezo electrostriction occurs when a voltage is applied between the two electrodes, is referred to as a “piezoelectric functional portion.” Although the lower electrode 24 is taken as the common electrode for the piezoelectric elements 18 and the upper electrodes 26 are taken as the individual electrodes for the piezoelectric elements 18 in this embodiment, it should be noted that a configuration in which this is generally reversed due to the polarization direction of the piezoelectric materials 25, the driving circuit, the state of the wiring, and so on is also possible. In either case, a piezoelectric functional portion is formed in correspondence with each of the pressure chambers 20. Meanwhile, lead electrodes 27 configured of gold (Au) or the like are connected to the upper electrodes 26 of the respective piezoelectric elements 18.

The protective substrate 19, which includes a piezoelectric element holding portion 28 serving as a space in a region that is opposed to the piezoelectric elements 18 and that has a size that does not interfere with the displacement of the piezoelectric elements 18, is connected to the surface of the flow channel formation substrate 14 that is on the same side as the piezoelectric elements 18. Furthermore, the reservoir portion 29 is provided in a region in the protective substrate 19 that corresponds to the communication portion 21 of the flow channel formation substrate 14. This reservoir portion 29 is formed in the protective substrate 19 as a through-hole having a long, rectangular opening shape that follows the direction in which the pressure chambers 20 are arranged, and as described earlier, by communicating with the communication portion 21 of the flow channel formation substrate 14, configures the reservoir 30, which serves as a common ink chamber that is shared by the pressure chambers 20.

Meanwhile, a through-hole 31 that passes through the protective substrate 19 in the thickness direction thereof is provided in a region of the protective substrate 19 that is between the piezoelectric element holding portion 28 and the reservoir portion 29; part of the lower electrode 24 and the tips of the lead electrodes 27 are exposed within this through-hole 31. A compliance substrate 34, configured of a sealing membrane 32 and an anchoring plate 33, is affixed to the top of the protective substrate 19. The sealing membrane 32 is configured of a flexible material (such as a polyphenylene sulfide film), and one of the surfaces of the reservoir portion 29 is sealed by the sealing membrane 32. The anchoring plate 33, meanwhile, is formed of a hard material such as a metal or the like (for example, stainless steel or the like). The region of the anchoring plate 33 that opposes the reservoir 30 has an opening portion 35 in which the anchoring plate 33 has been completely removed in the thickness direction, and thus one surface of the reservoir 30 is sealed using only the flexible sealing membrane 32.

With the recording head 2 configured as described thus far, ink is imported from an ink supply unit such as an ink cartridge or the like, and the interior area spanning from the reservoir 30 to the nozzles 23 is filled with ink; then, when a driving signal is supplied from the main printer unit, an electrical field based on the potential difference between the electrodes is applied between the lower electrode 24 and the upper electrodes 26 for each of the pressure chambers 20, which causes the piezoelectric elements 18 and the active surface (the elastic membrane 16) to bend and deform, which in turn causes the pressure within the pressure chambers 20 to fluctuate. By controlling these pressure fluctuations, ink is ejected through the nozzles 23, or meniscuses in the nozzles 23 are caused to vibrate slightly to a degree in which ink is not ejected.

With the recording head 2 according to this invention, each of the partitions 37 that separate adjacent pressure chambers from each other has a plurality of levels in the thickness direction, or in this embodiment, a total of three levels, configured of a first partition 37a, a second partition 37b, and a third partition 37c; the thicknesses of the partitions increase step-by-step from the side on which the active surface (the elastic membrane 16) is present to the side on which the nozzles 23 are present. In other words, the first partition 37a, which is located closest to the active surface, is the thinnest; the second partition 37b is thicker than the first partition 37a: and the third partition 37c, which is located closest to the nozzle 23, is the thickest. Accordingly, each of the pressure chambers 20 is configured of three pressure chambers 20a through 20c, each of which has a different width; the uppermost first pressure chamber 20a, which is closest to the active surface, is the widest, the second pressure chamber 20b is narrower than the first pressure chamber 20a, and the lowermost third pressure chamber 20c, which is closest to the nozzle 23, is the narrowest.

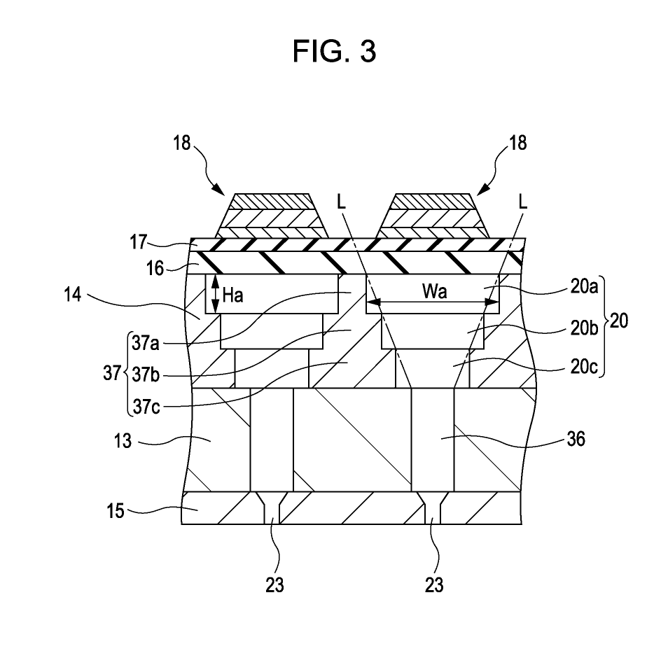

Here, the area of the opening of the uppermost first pressure chamber 20a, or in other words, the surface area of the active surface that seals that pressure chamber 20, is set so that the maximum amount by which the active surface displaces toward the inside of the pressure chamber (that is, toward the nozzle 23) when the corresponding piezoelectric element 18 is driven is a design-based target value. In other words, the area of the opening in the first pressure chamber 20a is set so that a compliance (that is, a flexibility) enabling the target value maximum displacement amount is imparted on the active surface. The width direction dimension Wa of the uppermost first pressure chamber 20a is set based on this, as shown in FIG. 3. Accordingly, the thickness of the first partition 37a is uniquely set based on the width Wa of the first pressure chamber 20a and the pitch at which the nozzles 23 are formed. The thickness of the first partition 37a is approximately the same as the partition thickness in past structures, in which the thicknesses of the partitions have been constant. Meanwhile, the dimension in the vertical direction of the first pressure chamber 20a (that is, the height in the direction perpendicular to the nozzle formation substrate 15), or in other words, a height Ha of the first partition 37a, is set to the minimum dimension in a range in which the level difference between the first partition 37a and the second partition 37b does not interfere with the active surface when the active surface has undergone the maximum displacement toward the inside of the pressure chamber. The height Ha of the first partition 37a is sufficiently less than the height of the partitions in the past structures, which increases the rigidity thereof.

Meanwhile, the thickness of the lowermost third partition 37c is set to be as thick as possible while remaining within a range in which the flow of ink from the pressure chamber 20 to the communication opening 36 and the nozzle 23 is not impeded, and specifically, a range in which the flow channel from the pressure chamber 20 to the nozzle 23 (in this embodiment, the communication opening 36) is not narrowed. Furthermore, the thickness of the remaining second partition 37b is set to be between the thickness of the first partition 37a and the thickness of the third partition 37c. In this embodiment, as shown in FIG. 3, the thicknesses of the second partition 37b and the third partition 37c are set so that the corners of all of the level portions are located upon an imaginary line L that connects the edge of the opening of the first pressure chamber 20a to the upper edge of the opening of the communication opening 36. Furthermore, the heights of the second partition 37b and the third partition 37c are set so that the flow channel resistance and entrance of the overall pressure chamber including the first pressure chamber 20a are design-based target values.

In this manner, the partitions 37 that separate the pressure chambers from each other are configured so as to have a plurality of levels having different thicknesses, and the partitions become thicker the further the chambers progress from the active surface to the nozzles 23; this makes it possible to increase the rigidity of the chambers as a whole without interfering with the displacement of the piezoelectric elements 18 and the active surface. Accordingly, the partitions 37 are suppressed from deforming (bending) toward their adjacent pressure chambers when the pressure within the pressure chambers 20 rises due to the piezoelectric elements 18 operating in order to eject ink from the nozzles 23. Through this, pressure loss occurring when ejecting ink is reduced, and crosstalk between adjacent nozzles is prevented. As a result, it is possible to suppress fluctuations in the ink ejection properties caused by crosstalk (that is, fluctuations in the amount, flight speed, and so on of the ink ejected through the nozzles 23). In addition, because the durability of the partitions 37 is increased, the reliability of the recording head 2 can be improved.

In this embodiment, the rigidity is increased by setting the thickness and height of the first partition 37a so as to achieve the maximum displacement amount for the active surface necessary when ejecting ink through the nozzles 23, and by setting the thickness and height of the third partition 37c thicker but within a range in which the flow of ink from the pressure chambers 20 to the nozzles 23 is not impeded; accordingly, the design-based target ink ejecting properties (the amount, the flight speed, and so on of the ink ejected from the nozzles 23) can be ensured with greater certainty.

Note that it is desirable to keep the level differences between partitions as low as possible, in order to prevent bubbles from accumulating to ensure that the ink within the pressure chambers 20 flows smoothly, and so as to increase the durability of the partitions 37. Accordingly, it is desirable for the partitions 37 to have at least three levels.

Furthermore, although so-called flexurally-vibrating piezoelectric elements 18 is described as an example of the pressure generation unit in the aforementioned embodiment, the pressurizing unit is not limited thereto, and, for example, a so-called longitudinally-vibrating piezoelectric element can be employed as well.

It should also be noted that the invention can be applied not only in printers but also in various types of ink jet recording apparatuses such as plotters, facsimile machines, and copiers, as well as in liquid ejecting apparatuses aside from such recording apparatuses, such as display manufacturing apparatuses, electrode manufacturing apparatuses, chip manufacturing apparatuses, and the like, as long as those devices are liquid ejecting heads or liquid ejecting apparatuses provided therewith that have a plurality of partitions that form a plurality of pressure chambers and that eject a liquid such as ink through a nozzle by using a pressure generation unit to cause an active surface that seals an opening surface of the pressure chambers to displace.

The entire disclosure of Japanese Patent Application No. 2011-002756, filed Jan. 11, 2011 is expressly incorporated by reference herein.

What is claimed is:

1. A liquid ejecting head, in which a plurality of pressure chambers that communicate with corresponding nozzles are formed by partitions, that ejects a liquid through the nozzles that communicate with the pressure chambers by causing an active surface that seals an opening surface of the pressure chambers to deform using a pressure generation unit and thus causing the pressure of the liquid within the pressure chambers to fluctuate,
wherein the partitions that separate adjacent pressure chambers from each other are formed having a plurality of levels, the plurality being three or more, so that the partitions become thicker from the side on which the active surface is present toward the side on which the nozzles are present.

2. The liquid ejecting head according to claim 1,
wherein of the plurality of partitions, the thickness and height of the partition located closest to the active surface are set so that a maximum displacement amount necessary for the active surface when ejecting the liquid through the nozzles is obtained; and
of the plurality of partitions, the thickness and height of the partition located closest to the nozzle are set to be thick within a range in which the flow channel from the pressure chamber to the nozzle is not narrowed.

3. A liquid ejecting apparatus including a liquid ejecting head, in which a plurality of pressure chambers that communicate with corresponding nozzles are formed by partitions, that ejects a liquid through the nozzles that communicate with the pressure chambers by causing an active surface that seals an opening surface of the pressure chambers to deform using a pressure generation unit and thus causing the pressure of the liquid within the pressure chambers to fluctuate,
wherein in the liquid ejecting head, the partitions that separate adjacent pressure chambers from each other are formed having a plurality of levels, the plurality being three or more, so that the partitions become thicker from the side on which the active surface is present toward the side on which the nozzles are present.
